(19) United States
(12) Patent Application Publication
(10) Pub. No.: US 2008/0033644 A1
(43) Pub. Date: Feb. 7, 2008

(54) Navigation Routing System Having Environmentally Triggered Routing

(76) Inventor: Sean A. Bannon, Bloomfield Hills, MI (US)

Correspondence Address: DAIMLERCHRYSLER INTELLECTUAL CAPITAL CORPORATION;CIMS 483-02-19, 800 CHRYSLER DR EAST, AUBURN HILLS, MI, 48326-2757, US

(21) Appl. No.: 11/832,703

(22) Filed: Aug. 2, 2007

Related U.S. Application Data
(60) Provisional application No. 60/821,304, filed on Aug. 3, 2006.

(51) Int. Cl. G01C 21/34; G01S 5/00; G06F 17/30

(52) U.S. Cl. 701/210

(57) ABSTRACT

A routing system and method for determining a user's geographical location and desired destination alerts the user to real or perceived threats to the user's safety or convenience by utilizing data bases containing both historical and real-time information about the user's geographical location and user-specified criteria.

### CROSS-REFERENCE TO RELATED APPLICATION

This application claims priority to U.S. Provisional Application No. 60/821,304, filed Aug. 3, 2006, and which is hereby incorporated by reference.

### FIELD

The invention generally relates to an improved navigation arrangement, and more specifically to providing a navigation arrangement capable of aiding in the personal safety and security of an end user.

### BACKGROUND

While traveling in unfamiliar areas, people are usually oblivious to possible threats to their own personal safety/security. Irrespective of real threats, a person in a new or unfamiliar surrounding may not feel safe or secure. While known GPS navigation devices/systems provide relative position and can also calculate travel routes, such systems do not account for real or perceived safety/security threats, i.e., such known arrangements typically only consider distance when determining a route, nor do they provide real time updates of local hazards and/or potential threats to the safety/security of a vehicle or user.

### SUMMARY

Accordingly, the present invention provides a hand held or on-board electronic device capable of alerting a user to real or perceived safety and/or security threats in their surrounding environment. Several technologies, including GPS, WiFi, Satellite Radio, Dedicated Short Range Communications (DSRC), can be employed in the device. A processor programmed with a predefined algorithm is arranged to determine threat level and allow a user to request a re-route of their trip to employ a lower threat path.

In accordance with one aspect of the present invention, a navigation device/system is provided that allows a person to make an objective, real-time assessment of possible safety/security threats attendant with their location, and then be automatically or selectively redirected to an area or travel path of less potential risk based on user defined criteria and rules. This capability will improve both real and perceived safety of the end user.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present teachings will become more fully understood from the detailed description and the accompanying drawings, wherein:

FIG. 1 is a navigational system/device in accordance with an exemplary embodiment of the present teachings illustrating the human/machine interface (HMI);

FIG. 2 is a flowchart of an example routing for controlling the navigation routing system;

FIG. 3 depicts a first embodiment of wireless communication between the navigation routing system and the internet;

FIG. 4 depicts a second embodiment of wireless communication between the navigation routing system and the internet; and

FIG. 5 depicts a third embodiment of wireless communication between the navigation routing system and the internet.

### DETAILED DESCRIPTION

The following description is merely exemplary in nature and is in no way intended to limit the invention, its application, or uses.

With the advent of Global Satellite Positioning Systems (GPS) it is possible for a person to precisely determine his/her position at any given time on a map. Moreover, for a given GPS location, extensive historical data exist in the public domain with respect to population demographics, crime, vehicle accidents, environmental hazards and the like. Probabilistic models, such as a Monte Carlo simulation, are applied to this data in an algorithm so as to identify possible security and/or safety threats by location. Examples of such threats include environmental (e.g. toxic waste dumps, air pollution, weather etc.), crime related (e.g. violent crime areas, persons of interest, carjacking etc.), accidents (high accident frequency areas), time dependent events such as traffic patterns during rush hour, natural hazards (e.g., storms, wild animal populations, flooded areas or falling rocks), and other population demographics or hazards that a user could custom define.

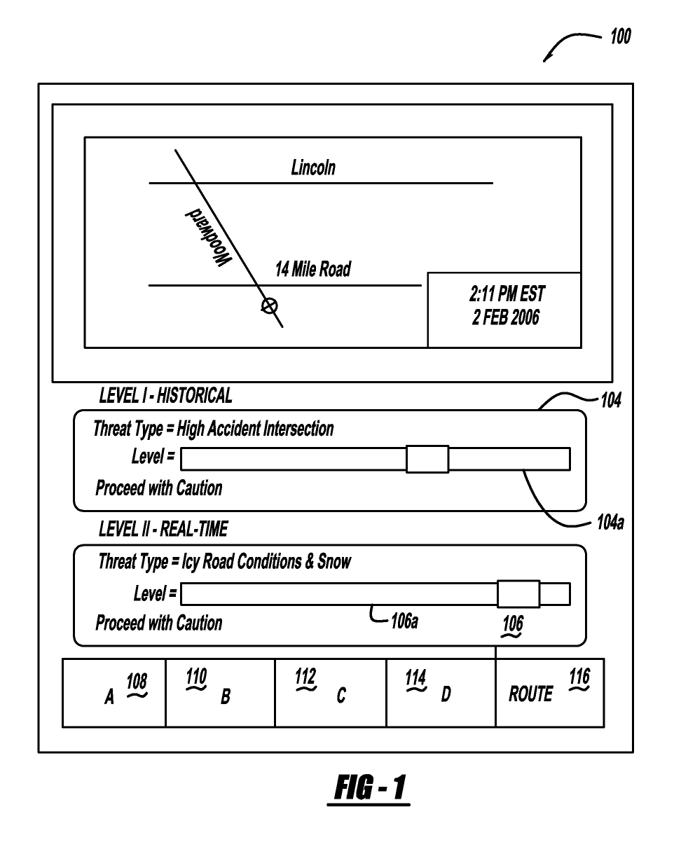

FIG. 1 presents an example of the routing system's human machine interface (HMI) 100. In addition to providing current GPS location as in conventional systems, at a GPS display 102, system 100 additionally allows a user to define specific concerns of interest using a menu and soft keys, such as 108, 110, 112, 114 and 116. Soft key 108 is used to define crime threat criteria, soft key 110 is used to define environmental threat criteria, soft key 112 is used to define natural hazard, soft key 114 is used to define traffic accident criteria and soft key 116 is used for re-routing.

Threat level can be defined using two discrete data sets—historical and real-time.

Historical information 104 from a database is used to determine the potential threat level for a specific locale. The algorithm may run a probabilistic model, such as a Monte Carlo simulation on the data as a person travels along in the vehicle. The algorithm additionally provides a probability of the user experiencing a safety/security threat for a given time and in a given location at bar graph 104a.

Real-time data 106 may be updated by high speed communication links as the user travels along. Specific threats could include traffic accidents, highway congestion ahead, severe weather updates, etc. Again, the threat level can, for example, be presented by a bar graph 106a. Alternatively, the threat level can be normalized on a 1-10 scale (no threat to full alert) for both levels of data. The system can then provide assistance to the end user, for example, by providing alerts and warnings concerning impending dangerous areas for crime, accidents or environmental concerns, or by calculating the safest travel route in view of both levels of information and analysis. For example, if a person has respiratory problems and desires to avoid areas with heavy air pollution, this set of criteria could be defined within the system. The routing system would then figure out a new route in which the ambient air pollution was lowest.

Using technology such as broadband WiFi systems and DSRC, the navigation routing system can be updated in real-time with accident and crime statistics, current traffic accident data and many other pieces of information that would be salient to the end user.

Using open architecture, such as Bluetooth technology, a vehicle based navigation routing system can be linked to work seamlessly with a broadband WiFi receiver device. In the event the end-user is threatened or is having health problems, an emergency button could be pushed on the device to notify the authorities of the GPS location and identification of the person calling via WiFi.

Satellite images may be superimposed on the GPS map 102 to provide additional clarity to the user.

Software implementing the features of the routing system may be resident in a remote computer or network of computers. A neural network is included in the routing system to learn the habits and preferences of the user or users and then to make adjustments to travel routing algorithms for avoiding specific threats and/or uncertainty. The system recognizes who is driving the vehicle based on pre-defined user profiles that may be identified by a button or other technologies, such as a unique key fob, etc.

In providing a model-based assessment of safety/security threats in real-time, the routing system can help improve the real and perceived safety of an end user by helping avoid potential trouble spots on the travel route selected. With respect to the HMI 100 of FIG. 1, the probability density of the threat could be plotted on the GPS screen 102 for real time conditions.

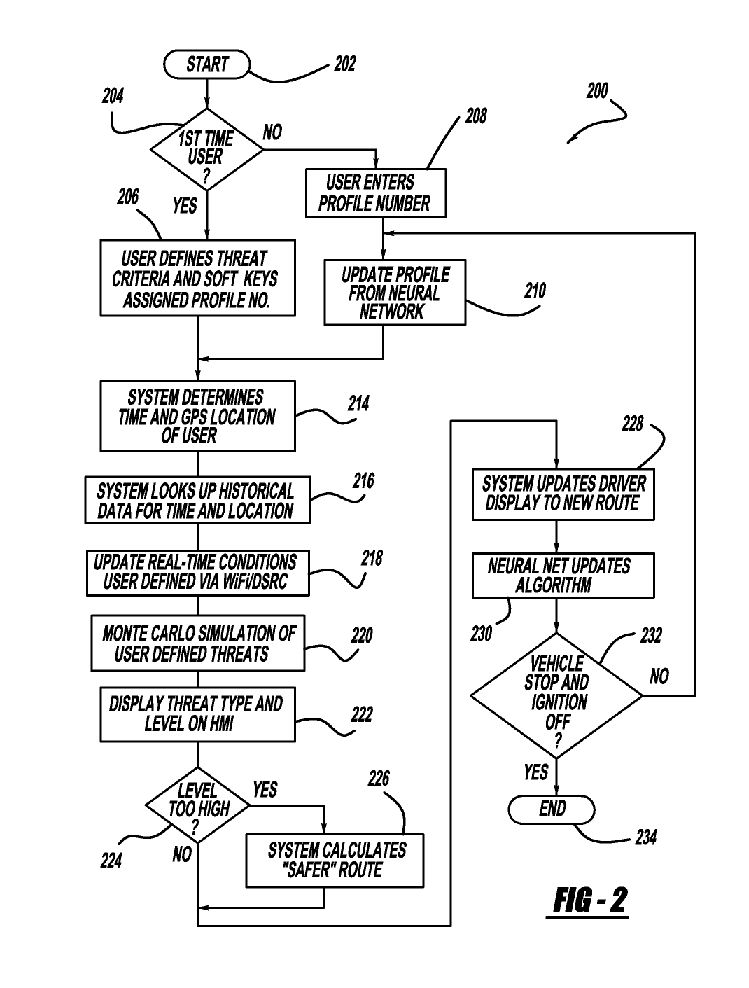

With reference to FIG. 2, an example algorithm for controlling the overall routing system is set forth in flowchart form.

The routine starts at 202 and proceeds to decision block 204 where it is determined whether or not this is a first time user of the system. If it is a first time user, the routine proceeds to block 206 wherein the user defines threat criteria using the soft keys of FIG. 1. Additionally, a profile number is assigned to the first time user.

If at decision block 204 it is not a first time user, the routine proceeds to block 208 where the user enters his or her profile number. The routine then proceeds to block 210 where the user's profile is updated from a neural network resident in the system.

The routine then proceeds to block 214 where the system determines the time and the GPS location of the user. The routine then proceeds to step 216 where the system looks up historical data related to the time and GPS location. At step 218, the routine updates real-time conditions using user defined selections. The user preferences have been communicated to the system using WiFi or DSRC.

At step 220, the routine uses a probabilistic model, such as a Monte Carlo simulation, to determine the threat level in accordance with criteria defined by the user.

At step 222, the routine displays the threat type and level at the human machine interface 100 of FIG. 1.

At decision block 224, if the level is determined to be unacceptably high in accordance with user defined criteria, then the routine at step 226 calculates a safer route. If the threat level is acceptable, then the routine proceeds directly to step 228 for update of the driver display. The determination of the threat level acceptability at decision block 224 may be implemented automatically within software of the routine or the user may manually request a safer route by observing the threat level displayed at HMI 100 of FIG. 1. Soft key 116 would be used by the user to request a new route.

At step 228, the system updates the driver display to a new route or to a new portion of the existing route.

At step 230, the neural network updates the algorithm based on what has been learned over time for the user identified by the current profile number.

At decision block 232, if the vehicle's ignition is off and the vehicle is stopped then the routine ends at 234. Otherwise, the routine returns to block 210 for further updating of the user's profile using the neural network. In terms of wireless communication between the vehicle and a host computer or computer network via the Internet, three example embodiments are provided.

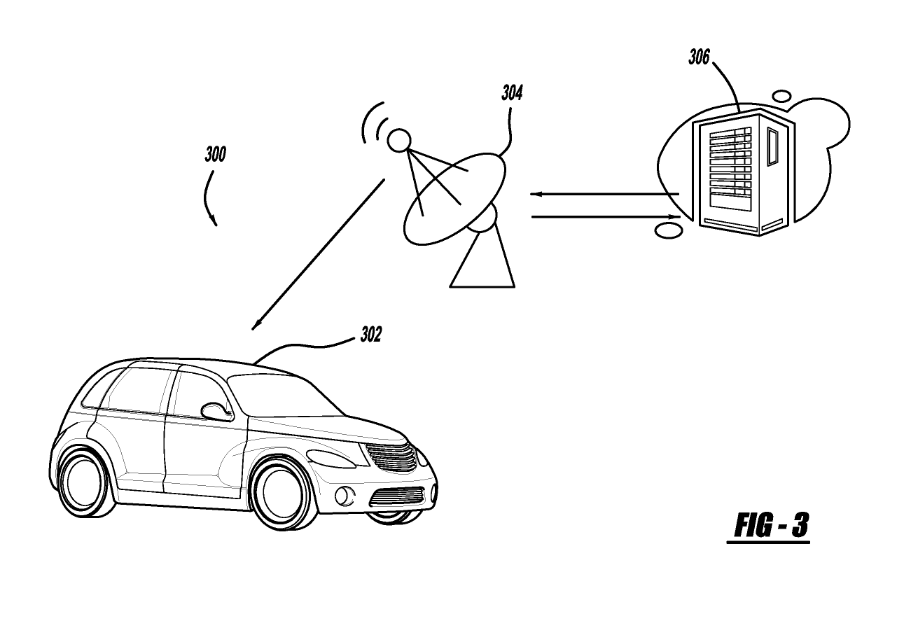

In a first embodiment 300 depicted in FIG. 3, the GPS system can be associated with an existing satellite radio system 304. The GPS can communicate the location of the vehicle 302 to the satellite radio 304, and then real-time data from the host computer 306 can be encoded with the normal digital entertainment signal from a satellite radio system for a specific local area, such as a city. Host computer 306 runs the programmed algorithm of FIG. 2 and processes all data.

With the vehicle satellite radio system 304 and communication with the GPS system, the data for the local area can be wirelessly sent and decoded from the signal for use in the GPS real-time threat alert system 300. The GPS system associates with the satellite radio system and selects the correct frequency for local conditions updated in real-time.

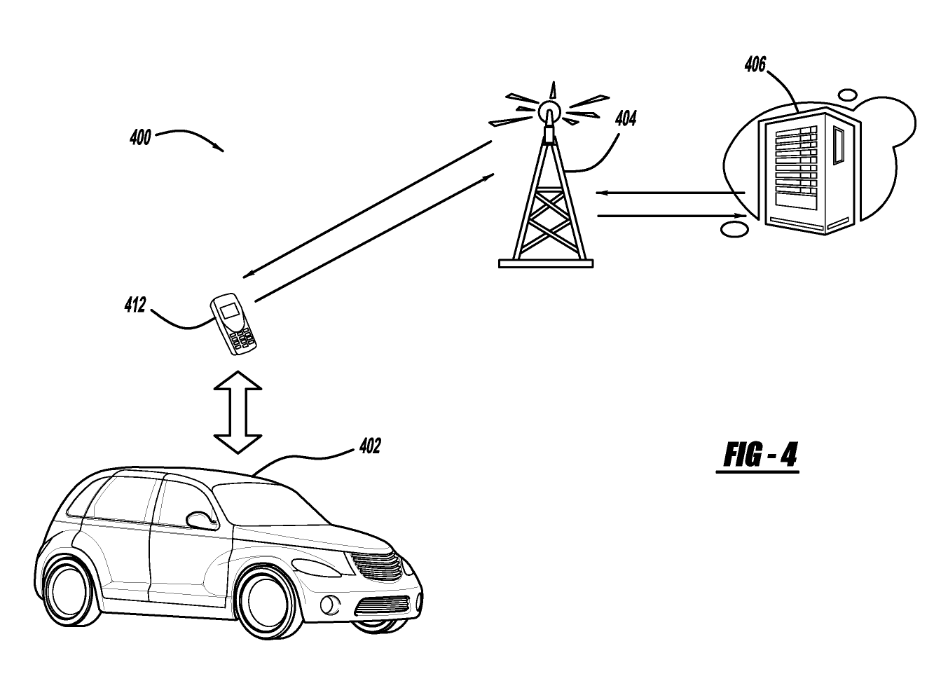

In the embodiment of FIG. 4, routing system 400 utilizes a Bluetooth web-enabled phone or a PDA-type device 412 to communicate with the vehicle GPS system to update real-time conditions to be faced by vehicle 402. Antenna 404 receives and transmits data from/to host computer 406.

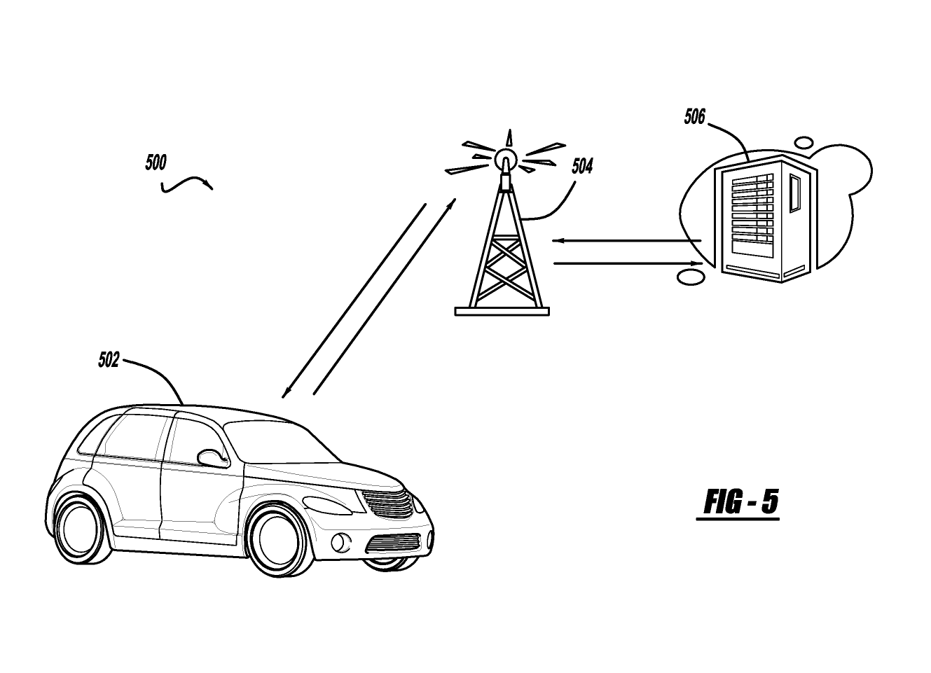

In the embodiment of FIG. 5, routing system 500 uses a high-speed Internet connection via WiFi or DSRC to update real-time conditions with the GPS system. Antenna 504 receives and transmits data from/to host computer 506.

While automotive applications are demonstrated herein, this is an example of only one application usable with the routing system. Using open architecture, alternatively, the same technology could be included in portable cell phones, wireless PDAs, laptops, GPS hand-held devices, etc.

For example, one alternative approach uses the technology in cell phones. Parents cannot only monitor the movements of their children, but they could also be called in real-time if a child goes into a threatening or unsafe area. The parent could call the child and instruct him/her to leave the area immediately. A parent could hit a user-defined key on the device and specify a direct route for the child out of the threatening area. A parent could then monitor the child as he/she travels along the specified path to safety.

In yet another alternative application, people could also monitor elderly relatives or others with chronic conditions such as Alzheimer's. In conjunction with other technologies, unique algorithms could be developed to detect if the disease sufferer is having a seizure or becoming disoriented. In the event such a condition occurs, an alarm on the end user's monitoring device could be triggered. The end user would then call the person being monitored to see if medical attention is required. If there is no answer, the exact GPS location can be transmitted to EMS personnel to speed up response time.

In another application, sales people or political canvassers attempting to target a specific population demographic could define rules in the system and then be shown areas of highest probability density on the screen. This would be an enormous time savings in terms of directing marketing focus on a geographical target area.

In another use of the system, people and/or animals with RF chips implanted could be monitored in real-time using the system. For example, if a paroled violent criminal is in the vicinity of the end user, the user can be notified of this and take evasive action to avoid the parolee.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A routing system for determining a user's geographical location and alerting the user to real or perceived safety or security threats in an area encompassing the geographical location; the system comprising:
an interface device adapted to communicate with a global positioning system (GPS) to display preselected GPS data, to accept criteria data defined by the user, and to display alerting information to the user; and
a routing system processor in communication with the interface device, the processor operative to employ a routing algorithm to determine a route to a destination designated by the user via the interface device, the processor further operative to alter the routing algorithm in accordance with the criteria data such that the route will avoid a specific threat or uncertainty.

2. The system of claim 1 wherein the interface device is hand-held by the user.

3. The system of claim 1 wherein the interface device is located on-board the user's vehicle.

4. The system of claim 1 wherein the interface device further comprises:
a plurality of soft keys for respectively enabling the user to define a plurality of threat criteria.

5. The system of claim 4 further comprising a soft key enabling the user to request re-routing.

6. The system of claim 1 wherein the routing system processor communicates with the interface device via a satellite radio system.

7. The system of claim 1 wherein the routing system processor communicates with the interface device via one of a web-enabled telephone and a PDA-type device.

8. The system of claim 1 wherein the routing system processor communicates with the interface device via an internet connection.

9. The system of claim 1 wherein the routing system processor utilizes a data base containing historical information for determining a potential threat level in a specific user locale.

10. The system of claim 9 wherein the routing system processor runs a probabilistic model on the historical information to determine the potential threat level.

11. The system of claim 1 wherein the routing system processor utilizes a data base containing real-time information for determining an actual threat level in a specific user locale.

12. The system of claim 9 wherein the routing system processor utilizes a data base containing real-time information for determining an actual threat level in the specific user locale.

13. The system of claim 1 wherein the routing system processor utilizes a neural network for learning habits and preferences of the user and updating the routing algorithm accordingly.

14. A method for controlling a user routing system comprising:
identifying the user via a profile indicator;
receiving threat criteria associated with the profile indicator via an interface device;
determining a geographical location and desired destination of the user;
determining an initial user route to the destination with a routing algorithm;
retrieving historical information about the location;
retrieving real-time information about the location;
running a probabilistic model on the retrieved information to determine threat type and level; and
selecting an alternate route to the destination whenever the threat level exceeds a predetermined level associated with the user.

15. The method of claim 14 further comprising updating a user profile using a neural network.

16. The method of claim 14 further comprising updating the routing algorithm using a neural network.

17. The method of claim 14 wherein the probabilistic model comprises a Monte Carlo model.
